(19) United States
(12) Patent Application Publication
(10) Pub. No.: US 2015/0284869 A1
(43) Pub. Date: Oct. 8, 2015

(54) Pretreatment Process for Magnesium Alloy Wheel

(71) Applicants: Zaide WANG, Qinhuangdao (CN); Yun DENG, Qinhuangdao (CN); Guangcai CHEN, Qinhuangdao (CN); Shengchao ZHANG, Qinhuangdao (CN); Liang FENG, Qinhuangdao (CN); Peng HAN, Qinhuangdao (CN)

(72) Inventors: Zaide WANG, Qinhuangdao (CN); Yun DENG, Qinhuangdao (CN); Guangcai CHEN, Qinhuangdao (CN); Shengchao ZHANG, Qinhuangdao (CN); Liang FENG, Qinhuangdao (CN); Peng HAN, Qinhuangdao (CN)

(73) Assignee: CITIC DICASTAL CO., LTD, Qinhuangdao (CN)

(21) Appl. No.: 14/675,849

(22) Filed: Apr. 1, 2015

(30) Foreign Application Priority Data
Apr. 3, 2014 (CN) 201410132704.4

(51) Int. Cl. C25D 13/20; B08B 3/10; C25D 13/14

(52) U.S. Cl. CPC C25D 13/20; C25D 13/14; B08B 3/10

(57) ABSTRACT

A pretreatment process for a magnesium alloy wheel is provided. The process flow is as follows: washing with hot water; degreasing; washing with hot water; acid washing for surface adjustment; washing with water; washing with pure water; performing chromium-free conversion treatment; washing with pure water; washing with pure water; sealing film; washing with pure water; baking; and spraying (electrophoresis). The process of the present invention can improve corrosion resistance of magnesium alloys and adhesion of surface coating thereof, realizing durable use of the surface of the magnesium alloy wheel. An immersion type treatment is adopted in the pretreatment, and therefore the process time is short, and the formed film is uniform and has good compactness. Application standard for corrosion-resistance of wheels can be reached by combining the pretreatment process with spraying and electrophoresis.

### TECHNICAL FIELD

The present invention relates to an alloy surface treatment process and particularly relates to a surface treatment process for a magnesium alloy wheel.

### BACKGROUND ART

Magnesium alloy has low density, high specific strength and good damping performance and is known as a “green engineering material in 21st century”. With the increasingly urgent lightweight demands for automobiles, the magnesium alloy shows great advantages on the automobiles, and wheels are typical parts using the magnesium alloy as new replacement materials in the field of a new generation of automobile products. However, the magnesium alloy wheels are difficult to popularize and used due to the restriction of low performances and poor corrosion resistance. The magnesium alloy is chemically active and prone to corrosion, and reliable surface protection measures must be adopted as a structural material. Particularly, as the parts undergoing the worst environmental conditions in the automobile wheels, the wheels are affected by not only outdoor climate environments, but also mud, sand, gravel impact and water sputtering on the ground, and thus there are problems of corrosion after scraping of surface coatings, electrochemical corrosion at the parts connected with bolts and shafts and the like. Thus, improving corrosion resistance becomes the key in promoting the application of the magnesium alloy wheels. At present, the surface treatment methods adopted for the magnesium alloy mainly comprise chemical conversion treatment, chemical oxidation, electrochemical oxidation, organic coating treatment, surface modification treatment, metal plating treatment and the like. The chemical conversion treatment is mainly used for priming of the subsequent organic coating treatment. The chemical oxidation and the electrochemical oxidation are only used as decoration and protection for intermediate processes, while organic coatings are soft in texture and likely to peel off, and the surface modification treatment technology is not mature, thus it is difficult to meet the anti-corrosion requirements of the magnesium alloy wheels.

### INVENTION CONTENTS

An object of the present invention is improving the corrosion resistance of the surface of a magnesium alloy wheel, and after treatment by the present invention, the surface of the magnesium alloy wheel forms a dense chromium-free ceramic conversion film, the thickness of a coating is uniform, the binding force with the coated coating is strong and the corrosion resistance is greatly enhanced.

The present invention relates to a pretreatment process for a magnesium alloy wheel and the main process flow is as follows: washing with hot water; degreasing; washing with hot water; acid washing for surface adjustment; washing with water; washing with pure water; performing chromium-free conversion treatment; washing with pure water; washing with pure water; sealing film; washing with pure water; baking; and spraying (electrophoresis). The main process parameters are as follows:

Washing with hot water: the temperature of the hot water for washing is in the range of 35-50° C., and the washing time is in the range of 1-2 minutes; the surface temperature of the wheel is increased and dust on the surface is flushed.

Degreasing: alkali washing is performed, the pH is in the range of 9.0-9.5, the number of free alkali points is in the range of 20-30 and the soaking time is in the range of 1-2 minutes.

Washing with hot water: the temperature of the hot water for washing is in the range of 35-50° C., the washing time is in the range of 1-2 minutes and the surface remainders of the wheel after degreasing is washed.

Acid washing for surface adjustment: acid washing is performed, the pH is in the range of 2.0-2.5; the acid concentration is in the range of 5.5-6.5 points, the temperature is in the range of 15-35° C. and the washing time is in the range of 1-2 minutes; and oxides on the surface of the wheel are mainly washed and surface metals are activated.

Washing with water: the temperature is in the range of 15-35° C., the washing time is in the range of 2-3 minutes and the remaining pickle on the surface of the wheel is washed.

Washing with pure water: the temperature is in the range of 15-35° C., the washing time is in the range of 2-3 minutes and the electric conductivity is less than or equal to 30 μs/cm; and the surface cleanliness is ensured.

Chromium-free conversion treatment: the temperature is in the range of 15-35° C., the washing time is in the range of 1-2 minutes, the pH is in the range of 2.0-2.5 and the electric conductivity is in the range of 2000-3500 μs/cm; and a surface dense ceramic chemical conversion film is formed.

Washing with pure water: the temperature is in the range of 15-35° C., the washing time is in the range of 2-3 minutes and the electric conductivity is less than or equal to 30 μs/cm; and the surface cleanliness is ensured.

Film sealing: the temperature is in the range of 40-65° C., the washing time is in the range of 1-3 minutes and the electric conductivity is in the range of 100-300 μs/cm; and the conversion film is denser after hole sealing treatment of the ceramic conversion film.

Washing with pure water: the temperature is in the range of 15-35° C., the washing time is in the range of 2-3 minutes and the electric conductivity is less than or equal to 15 μs/cm; and the surface cleanliness is ensured.

Baking: the baking is performed by an oven, the temperature of workpieces is greater than or equal to 120° C. and the time is above 15 minutes.

Powder coating: an automatic electrostatic powder spraying device is adopted, the construction voltage is controlled at 50-80 kv, the powder coating amount is in the range of 160-195 m³/h, the curing is performed by a continuous circulating air curing furnace, the curing temperature is from 175° C. to 180° C. and the heat preservation time is in the range of 10-20 minutes.

Electrophoresis coating: an electrophoresis way is adopted for protecting a flange, a bolt hole and a valve hole, and the electrophoresis parameters are as follows: the content of solid powder is in the range of 17-20%, the pH is in the range of 6.2-6.4, the electrolysis voltage is in the range of 180-260v, and the electrolysis time is in the range of 2-4 minutes. The curing and baking temperature is 160° C. and the heat preservation time is in the range of 20-30 minutes.

In the present invention, tests for performances of the coating were carried out, In an adhesion cross-cut test, no shedding occurred; in a scribe CASS test, the corrosion widths were less than or equal to 3 mm, and the coating had no change after 240 h of water resistance, and in a FILIFOR test for corrosion, the corrosion widths were less than or equal to 4 mm.

### DETAILED DESCRIPTION

The present invention is described in detail by the specific embodiments directed at the process parameters of the present invention.

### EXAMPLE 1

washing with hot water: the temperature of the hot water for washing is 35° C. and the washing time is 1 minute; degreasing: alkali washing is performed, the pH is 9.0, the number of free alkali points is 23 and the soaking time is 1 minute; washing with hot water: the temperature of the hot water for washing is 40° C., the washing time is 2 minutes and the surface of the wheel is washed for degreasing the remaining grease; acid washing for surface adjustment: acid washing is performed, the pH is 2.3; the acid concentration is 5.8 points, the temperature is 15° C. and the washing time is 2 minutes; washing with water: the temperature is 20° C. and the washing time is 2 minutes; washing with pure water: the temperature is 20° C., the washing time is 2 minutes and the electric conductivity is 23 μs/cm; chromium-free conversion treatment: the temperature is 18° C., the washing time is 1 minute, the pH is 2.3 and the electric conductivity is 2150 μs/cm; washing with pure water: the temperature is 25° C., the washing time is 2 minutes and the electric conductivity is 10 μs/cm; sealing film: the temperature is 50° C., the washing time is 1 minute and the electric conductivity is 108 μs/cm; washing with pure water: the temperature is 25° C., the washing time is 2 minutes and the electric conductivity is 10 μs/cm; baking: the baking is performed by an oven, the temperature of workpieces is 120° C. and the time is 20 minutes. Powder coating: an automatic electrostatic powder spraying device is adopted, the construction voltage is controlled at 75 kv, the powder coating amount is 180 m³/h, the curing is performed by a continuous circulating air curing furnace, the curing temperature is 180° C. and the heat preservation time is 120 minutes.

The tests for performances of the coating were carried out. In an adhesion cross-cut test, no shedding occurred; in a scribe CASS test, the corrosion widths were 2.5 mm, and the coating had no change after 240 h of water resistance, and in a FILIFOR test for corrosion, the corrosion widths were 3.0 mm.

### EXAMPLE 2

washing with hot water: the temperature of the hot water for washing is 30° C. and the washing time is 1.5 minutes; degreasing: alkali washing is performed, the pH is 9.2, the number of free alkali points is 27 and the soaking time is 1 minute; washing with hot water: the temperature of the hot water for washing is 38° C., the washing time is 2 minutes and the surface remainders of the wheel after degreasing is washed; acid washing for surface adjustment: acid washing is performed, the pH is 2.4, the acid concentration is 6.0 points, the temperature is 22° C. and the washing time is 1 minute; washing with water: the temperature is 25° C. and the washing time is 2 minutes; washing with pure water: the temperature is 24° C., the washing time is 2 minutes and the electric conductivity is 20 μs/cm; chromium-free conversion treatment: the temperature is 22° C., the washing time is 1.2 minutes, the pH is 2.2 and the electric conductivity is 2450 μs/cm; washing with pure water: the temperature is 23° C., the washing time is 3 minutes and the electric conductivity is 8 μs/cm; sealing film: the temperature is 55° C., the washing time is 1 minute and the electric conductivity is 120 μs/cm; washing with pure water: the temperature is 30° C., the washing time is 2 minutes and the electric conductivity is 5 μs/cm; and baking: the baking is performed by an oven, the temperature of workpieces is 140° C. and the time is 15 minutes.

Electrophoresis coating: an electrophoresis way is adopted for protecting a flange, a bolt hole and a valve hole, and the electrophoresis parameters are as follows: the content of solid powder is 18%, the pH is 6.2, the electrolysis voltage is 195v, and the electrolysis time is 4 minutes. The curing and baking temperature is 160° C. and the heat preservation time is 25 minutes.

The tests for performances of the coating were carried out. In an adhesion cross-cut test, no shedding occurred; in a scribe CASS test, the corrosion widths were 1.5 mm, and the coating had no change after 240 h of water resistance, and in a FILIFOR test for corrosion, the corrosion widths were 3.2 mm.

1. A pretreatment process for a magnesium alloy wheel, characterized in that the process flow is as follows: washing with hot water; degreasing; washing with hot water; acid washing for surface adjustment; washing with water; washing with pure water; performing chromium-free conversion treatment; washing with pure water; washing with pure water; sealing film; washing with pure water; baking; and spraying (electrophoresis);
washing with hot water: wherein the temperature of the hot water for washing is in the range of 35-50° C. and the washing time is in the range of 1-2 minutes;
degreasing: wherein alkali washing is performed, the pH is in the range of 9.0-9.5, the number of free alkali points is in the range of 20-30 and the soaking time is in the range of 1-2 minutes;
washing with hot water: wherein the temperature of the hot water for washing is in the range of 35-50° C. and the washing time is in the range of 1-2 minutes;
acid washing for surface adjustment: wherein acid washing is performed, the pH is in the range of 2.0-2.5; the acid concentration is in the range of 5.5-6.5 points, the temperature is in the range of 15-35° C. and the washing time is in the range of 1-2 minutes;
washing with water: wherein the temperature is in the range of 15-35° C. and the washing time is in the range of 2-3 minutes;
washing with pure water: wherein the temperature is in the range of 15-35° C., the washing time is in the range of 2-3 minutes and the electric conductivity is less than or equal to 30 μs/cm;
chromium-free conversion treatment: wherein the temperature is in the range of 15-35° C., the washing time is in the range of 1-2 minutes, the pH is in the range of 2.0-2.5 and the electric conductivity is in the range of 2000-3500 μs/cm;
washing with pure water: wherein the temperature is in the range of 15-35° C., the washing time is in the range of 2-3 minutes and the electric conductivity is less than or equal to 30 μs/cm;
sealing film: wherein the temperature is in the range of 40-65° C., the washing time is in the range of 1-3 minutes and the electric conductivity is in the range of 100-300 μs/cm;
washing with pure water: wherein the temperature of the pure water for washing is in the range of 15-35° C., the washing time is 2-3 minutes and the electric conductivity is less than or equal to 15 μs/cm;
baking: wherein the baking is performed by an oven, the temperature of workpieces is greater than or equal to 120° C. and the time is above 15 minutes;
powder coating: wherein an automatic electrostatic powder spraying device is adopted, the curing temperature is in the range of 175-180° C. and the heat preservation time is in the range of 10-20 minutes; and
electrophoresis coating: wherein an electrophoresis is adopted for protecting a flange, a bolt hole and a valve hole, the curing and baking temperature is 160° C. and the heat preservation time is in the range of 20-30 minutes.

2. The pretreatment process for a magnesium alloy wheel according to claim 1, characterized in that, washing with hot water: wherein the temperature of the hot water for washing is 35° C. and the washing time is 1 minute; degreasing: wherein alkali washing is performed, the pH is 9.0, the number of free alkali points is 23 and the soaking time is 1 minute; washing with hot water: wherein the temperature of the hot water for washing is 40° C. and the washing time is 2 minutes; acid washing for surface adjustment: wherein acid washing is performed, the pH is 2.3, the acid concentration is 5.8 points, the temperature is 15° C. and the washing time is 2 minutes; washing with water: wherein the temperature is 20° C. and the washing time is 2 minutes; washing with pure water: wherein the temperature is 20° C., the washing time is 2 minutes and the electric conductivity is 23 μs/cm; chromium-free conversion treatment: wherein the temperature is 18° C., the washing time is 1 minute, the pH is 2.3 and the electric conductivity is 2150 μs/cm; washing with pure water: wherein the temperature is 25° C., the washing time is 2 minutes and the electric conductivity is 10 μs/cm; sealing film: wherein the temperature is 50° C., the washing time is 1 minute and the electric conductivity is 108 μs/cm; washing with pure water: wherein the temperature is 25° C., the washing time is 2 minutes and the electric conductivity is 10 μs/cm; and baking: wherein the baking is performed by an oven, the temperature of workpieces is 120° C. and the time is 20 minutes.

3. The pretreatment process for a magnesium alloy wheel according to claim 1, characterized in that, washing with hot water: wherein the temperature of the hot water for washing is 30° C. and the washing time is 1.5 minutes; degreasing: wherein alkali washing is performed, the pH is 9.2, the number of free alkali points is 27 and the soaking time is 1 minute; washing with hot water: wherein the temperature of the hot water for washing is 38° C., the washing time is 2 minutes, and the surface remainders of the wheel after degreasing is washed; acid washing for surface adjustment: wherein acid washing is performed, the pH is 2.4, the acid concentration is 6.0 points, the temperature is 22° C. and the washing time is 1 minute; washing with water: wherein the temperature is 25° C. and the washing time is 2 minutes; washing with pure water: wherein the temperature is 24° C., the washing time is 2 minutes and the electric conductivity is 20 μs/cm; chromium-free conversion treatment: wherein the temperature is 22° C., the washing time is 1.2 minutes, the pH is 2.2 and the electric conductivity is 2450 μs/cm; washing with pure water: wherein the temperature is 23° C., the washing time is 3 minutes and the electric conductivity is 8 μs/cm; sealing film: wherein the temperature is 55° C., the washing time is 1 minute and the electric conductivity is 120 μs/cm; washing with pure water: wherein the temperature is 30° C., the washing time is 2 minutes and the electric conductivity is 5 μs/cm; and baking: wherein the baking is performed by an oven, the temperature of workpieces is 140° C. and the time is 15 minutes.
